(19) United States
(12) Patent Application Publication
(10) Pub. No.: US 2004/0079259 A1
(43) Pub. Date: Apr. 29, 2004

(54) Method of manufacturing cementitious materials

(76) Inventor: Felix Manig, Muhlberg (DE)

Correspondence Address: MEREK & VOORHEES, 673 South Washington Street, Alexandria, VA, 22314, US

(21) Appl. No.: 10/282,025

(22) Filed: Oct. 29, 2002

(51) Int. Cl. B28B 3/00; C04B 14/00; C04B 24/00; C04B 2/00; C04B 28/10

(52) U.S. Cl. 106/724; 264/333; 106/796

(57) ABSTRACT

A method of manufacturing cementitious materials. The method comprises combining together approximately 12 parts sand with 1 part lime to form a sand and lime mixture where mixture has a sufficient water content to permit at least partial hydration of the lime. The sand and lime mixture is maintained at a temperature of approximately 60° Celsius for a period of between two and four hours. Thereafter water is mixed into the sand and lime mixture at a weight ratio of from between 5 to 15 percent. Pieces of shredded automobile or truck tires are then added to the sand, lime and water mixture at a weight ratio of between 5 and 15 percent. The combination is then subjected to an autoclave process where it is maintained at a pressure of approximately 16 Bar and at temperatures of between 160 and 180 degrees Celsius for between four and eight hours during which the mixture is allowed to cure and harden.

### FIELD OF THE INVENTION

This invention relates to a method of manufacturing cementitious materials, and in one aspect a method of manufacturing such materials that contain rubber particles, such as pieces of shredded automobile and truck tires.

### BACKGROUND OF THE INVENTION

Due to its high strength, general availability, and relatively low cost, concrete is used in an extremely wide variety of different building and construction applications. In some applications concrete may be mixed and poured in-situ at a particular building site. In other cases a cementitious or concrete product may be manufactured in a factory where raw materials are mixed, poured into a mold and subjected to an autoclave process where the material is cured and hardened in order to form a particular molded product. One of the more common products manufactured in this manner is the standard concrete block. However, a variety of other products, including concrete steps and stairs, concrete pipes, concrete benches, and concrete ornamental products, are also made using similar processes.

Manufactured concrete blocks are typically utilized for residential and commercial construction where they are commonly mortared together to form walls, posts and other load bearing structures. The uniform shape, relatively light weight, and high load bearing capacity of concrete blocks have made them a widely used and highly desirable construction material. However, as with all products, there is an ever increasing desire to strive to reduce production costs and increase or enhance the physical characteristics of concrete blocks. In particular, there is a continuing desire to enhance the thermal insulating capacity of concrete blocks in order to minimize the heating and cooling costs of buildings. Further, on account of its weight a major component of the overall cost of a concrete block (and for that matter virtually all concrete or cement products) comprises the costs associated with transporting the product from its manufacturing facility to a construction site. Accordingly, there also exists a continuing desire to develop methods of reducing the weight of concrete blocks and other concrete or cement products, without significantly affecting their strength, in order to minimize transportation costs.

Unrelated to the production of concrete blocks and other cementitious products, modern society faces a continuing and rapidly expanding environmental problem related to the disposal of used automobile and truck tires. Each year literally hundreds of millions of used automobile and truck tires are discarded and are typically sent to landfill sites or holding facilities. Disposing of used tires in landfill sites is an unattractive option due to the sheer volume of tires that are produced on an annual basis, and since tires do not naturally decay. Melting used tires and separating their component parts for recycling has been suggested. However, the processing that is involved makes the venture in most instances cost prohibitive. Incinerating tires is environmentally hazardous due to the toxicity of the various hydrocarbon and other compounds released during the combustion process. While others have proposed alternate methods of disposing of used automobile and truck tires, to date none of proven to be of economic significance, or are of a nature that is likely to be capable of utilizing a significant number of used tires on a continuing basis.

### SUMMARY OF THE INVENTION

The invention therefore provides a method of manufacturing cementitious materials that provides a product having enhanced physical characteristics and that at the same time provides a means of utilizing used automobile and truck tires, or a variety of similar materials, or a in an environmentally friendly manner.

Accordingly, in one of its aspects the invention provides a method of manufacturing cementitious materials, the method comprising the steps of combining together approximately 12 parts sand with 1 part lime to form a sand and lime mixture, said sand and lime mixture having a sufficient water content to permit at least partial hydration of said lime; maintaining said sand and lime mixture at a temperature of approximately 60° Celsius for a period of between two and four hours; mixing water into said sand and lime mixture at a weight ratio of from between 5 to 15 percent; adding and mixing pieces of shredded automobile or truck tires to said sand, lime and water mixture at a weight ratio of between 5 and 15 percent; subjecting said sand, lime, water and shredded tire mixture to an autoclave process wherein said mixture is maintained at a pressure of approximately 16 Bar and at temperatures of between 160 and 180 degrees Celsius for between four and eight hours during which said mixture is allowed to cure and harden.

In a further aspect the invention provides A cementitious material comprising (i) 60 to 80 percent by weight sand, gravel or aggregate; (ii) 5 to 15 percent by weight portland cement; (iii) 5 to 15 percent by weight water; and (iv) 5 to 15 percent by weight shredded automobile tires, truck tires, or recycled rubber.

In yet a further embodiment the invention concerns a method of manufacturing cementitious materials, the method comprising the steps of forming a mixture of sand, cement, water and fragmented rubber or plastic material, said sand component comprising from 60 to 80 percent by weight of said mixture, said cement component comprising from 5 to 15 percent by weight of said mixture, said water component comprising from 5 to 15 percent by weight of said mixture, said fragmented rubber or plastic material comprising from 5 to 15 percent by weight of said mixture; subjecting said sand, cement, water and fragmented rubber or plastic mixture to an autoclave process wherein said fragments of rubber or plastic material expand creating small pockets or voids within said mixture, said mixture curing and hardening during said autoclave process such that said pockets or voids become permanently entrained within said hardened mixture.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a flow chart showing the general stages of one embodiment of the present invention that results in the formation of a cement product.

FIG. 2 is a flow chart showing the general stages of a second embodiment of the present invention that results in the formation of a concrete product.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

Cement, or as it is often referred to in the industry portland cement, is generally formed by heating or slaking lime (typically limestone or chalk) with clay or shale particles. The resulting product is comprised primarily of aluminates and silicates of calcium that, when mixed with water, undergo a set of relatively complex chemical reactions followed by crystallization that produces a hard, solid material. When sand, gravel, aggregate or a combination of such materials is included in the mixture the resulting product is generally referred to as concrete.

In the manufacturing of concrete blocks, and other pre-formed concrete or cement products, it is common to prepare a concrete or cement mixture having a desired set of physical characteristics (for example a given lime-to-sand ratio, the inclusion of particular chemical additives for strength, hardening etc.) and to add the combination to a mixing device that mixes, delivers and presses the product into a mold. The product is then typically removed from the mold or blank and subjected to a autoclave process where the mixture is hardened under steam pressure and at elevated temperatures. In the autoclave the mixture is allowed to set and cure under strictly controlled pressures and temperatures in order to form a relatively consistent, high-strength product that would generally not be easily attainable if the mixture were allowed to harden under normal atmospheric conditions. In some instances, such as in hot arid climates, it may be possible to allow the mixture to air cure without significantly affecting the strength and other characteristics of the finished product. After the autoclave or curing process is completed the product is typically prepared for shipping and sale.

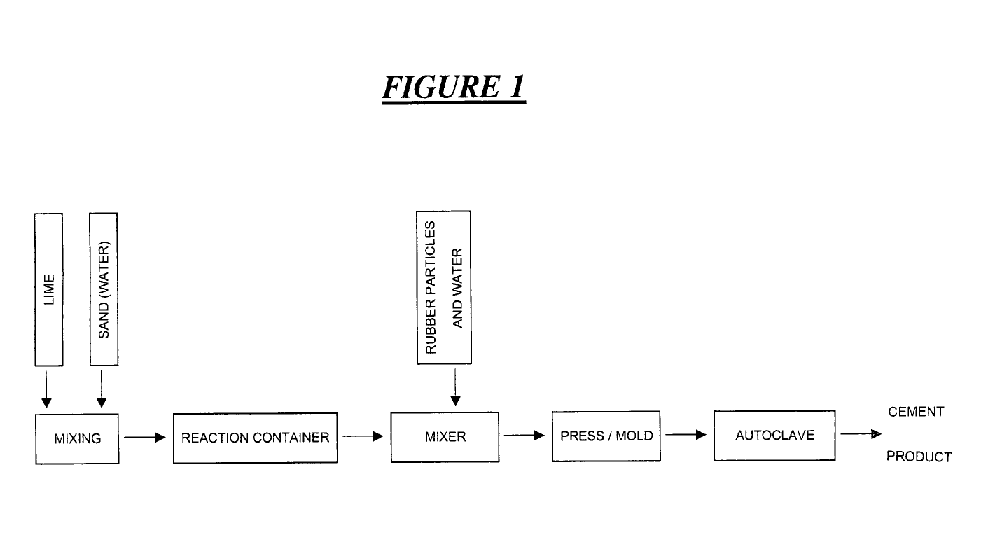

Having in mind the above generalized manufacturing process, the present invention provides a method of enhancing the physical characteristics of a cementitious product while at the same time providing a means to dispose of used automobile and truck tires or other sources of used rubber or similar materials Under one aspect of the inventive process (see FIG. 1) a lime-to-sand mixture of mixture of approximately 12 parts sand and 1 part lime, together with a sufficient amount of water to hydrate the lime, is thoroughly mixed and placed within a reaction container where it is maintained at atmospheric pressure and at a temperature of approximately 60° Celsius for a period of approximately 2 to 4 hours. During this time the lime will tend to slake to lime hydrate. Thereafter shredded automobile tires (and/or other similar materials) are added at a preferred weight ratio of approximately 5 to 15 percent. Water is also added to the mixture with the shredded rubber at a weight percent of approximately 5 to 15 percent. The tires or similar materials are preferably shredded or chopped into relatively small pieces or fragments (generally less than 10 millimetres and preferably approximately 3 to 4 millimeters in size) through the use of any one of a wide variety of currently available shredding or chipping devices. The fragments are then mixed into the slaked sand and lime mixture through the use of a silo and scale mechanism to achieve a desired weight ratio of shredded tires relative to the sand and lime mixture.

Once the shredded fragments and the additional water have been added and thoroughly mixed into the sand and lime composition the mixture may then be sent to a press where it can be formed into the shape of a desired end product (for example a cement block). Alternatively, the mixture may be injected directly into a mold. Once formed into a desired shape, the mixture is subjected to an autoclave process where it is allowed to cure and harden under steam pressure of approximately 16 Bar and at temperatures of approximately 160 to 180° Celsius for approximately 4 to 8 hours. During the autoclave process the heated pieces of rubber or similar materials expand creating small pockets or voids within the product. After the product has been removed from the autoclave and allowed to cool, the expanded rubber contracts, thereby creating small, generally hollow, voids spaced throughout the finished product.

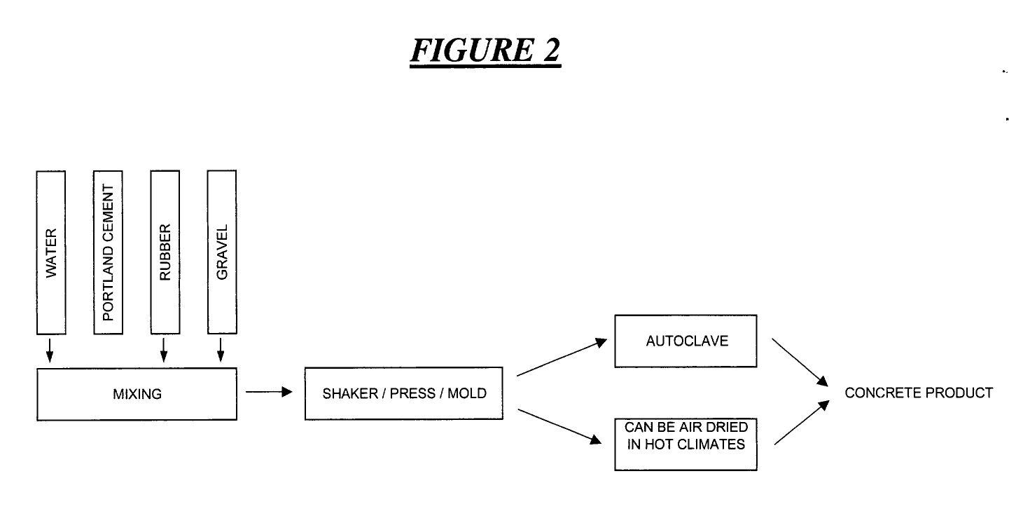

FIG. 2 is a flow chart that illustrates the major steps of an alternate embodiment of the invention wherein the end product is concrete as opposed to cement. While the processes is depicted in FIGS. 1 and 2 are parallel and comprise alternate embodiments of the present invention, since FIG. 2 is concerned with the formation of a concrete product the components that are initially mixed together comprise portland cement, water, rubber and a gravel, sand and/or aggregate component. Typically the mixture would be comprised of 60 to 80 weight percent sand, gravel and/or aggregate; 5 to 15 weight percent portland cement; 5 to 15 weight percent water; and from 5 to 15 percent shredded automobile tires, truck tires, recycled rubber or similar materials. Once the various components are thoroughly combined the mixture is sent to a press where it can be formed into the shape of desired product. Alternatively, the mixture may be directly injected into a mold having a desired configuration. Thereafter the product is subjected to an autoclave process similar to that as described above with respect to FIG. 1. Within the autoclave the mixture is allowed to harden and cure under a steam pressure of approximately 16 Bar and at a temperature of from between approximately 160 to 180° Celsius for approximately 4 to 8 hours. Once again, the heated rubber (or similar materials) expand creating small pockets or voids within the product that remain as generally hollow voids spaced throughout the finished product following completion of the autoclave process. As indicated above, for some products that are manufactured in climates that are particularly hot and arid, it may be possible to dispense with the use of an autoclave and allow the products to air harden and cure.

The small voids in the cement or concrete product formed through the contraction of the rubber or similar material during the cooling process have been found to have no appreciable or significant deleterious effect upon the overall usefulness of the product. While compressive strength will be reduced to a small degree (in the range of approximately 6% for most products), products manufactured pursuant to the described method have been found to perform satisfactorily, even when formed into concrete blocks. The voids do, however, tend to have a favourable effect upon the product's thermal insulation capacity. The voids that are disbursed throughout the product are essentially sealed gas or vacuum spaces that enhance the insulating capacity of the product as a whole. Furthermore, the residual rubber within the voids has been found to reduce the capacity of the product to conduct sound and provides a sound dampening effect. The rubber also presents no deleterious effect with respect to the absorption of moisture. In addition, the manufactured product is somewhat lighter in weight presenting economic advantages from a material handling and transportation perspective. Finally, since the rubber particles mixed throughout the product do not absorb moisture during processing (as does the sand/lime mixture) the addition of the rubber fragments or similar materials has the added effect of lessening the reduction in volume that is normally experienced during the curing process of standard cement or concrete.

It will therefore be appreciated that the method of the present invention provides a number of substantial advantages from both an economic and an environmental standpoint. The method allows for the safe and economic disposal of automobile and truck tires in an environmentally friendly manner. There is also presented the ability to produce concrete blocks or other cement or concrete products with enhanced thermal insulating capacities that are lighter in weight, that have a reduced capacity to transmit sound, and that are themselves completely recyclable. Furthermore, the abundance and availability of used automobile and truck tires presents a source of rubber for cement and concrete manufacturers that is essentially both limitless and in many instances cost free.

It is to be understood that what has been described are the preferred embodiments of the invention and that it may be possible to make variations to these embodiments while staying within the broad scope of the invention. Some of these variations have been discussed while others will be readily apparent to those skilled in the art. For example, while recycled and shredded automobile and truck tires are utilized within the cement or concrete mixture it will be appreciated that other sources of recycled or virgin rubber, plastic, or similar products could equally be used while staying within the scope of the invention.

We claim:

1. A method of manufacturing cementitious materials, the method comprising the steps of:
(i) combining together approximately 12 parts sand with 1 part lime to form a sand and lime mixture, said sand and lime mixture having a sufficient water content to permit at least partial hydration of said lime;
(ii) maintaining said sand and lime mixture at a temperature of approximately 60° Celsius for a period of between two and four hours;
(iii) mixing water into said sand and lime mixture at a weight ratio of from between 5 to 15 percent;
(iv) adding and mixing pieces of shredded automobile or truck tires to said sand, lime and water mixture at a weight ratio of between 5 and 15 percent;
(v) subjecting said sand, lime, water and shredded tire mixture to an autoclave process wherein said mixture is maintained at a pressure of approximately 16 Bar and at temperatures of between 160 and 180 degrees Celsius for between four and eight hours during which said mixture is allowed to cure and harden.

2. The method as claimed in claim 1 wherein said tires are shredded into pieces of approximately three to four millimetres in size prior to combining with said sand, lime and water mixture.

3. The method as claimed in claim 1 including the step of placing said sand, lime, water and shredded tire mixture into a mold or press to form said mixture into a desired shape and thereafter subjecting said desired shape to said autoclave process.

4. The method as claimed in claim 1 wherein upon subjecting said sand, lime, water and shredded tire mixture to said autoclave process, said pieces of shredded tires expand creating small pockets or voids within said material, upon curing and hardening of said material said voids becoming permanently maintained within said material.

5. A cementitious material comprising:
(i) 60 to 80 percent by weight sand, gravel or aggregate;
(ii) 5 to 15 percent by weight portland cement;
(iii) 5 to 15 percent by weight water; and
(iv) 5 to 15 percent by weight shredded automobile tires, truck tires, or recycled rubber.

6. The material as claimed in claim 5 wherein said automobile tires, truck tires, or recycled rubber are shredded to a size of approximately three to four millimetres.

7. The material as claimed in claim 6 wherein upon heating, said shredded pieces of automobile tires, truck tires, or recycled rubber expand creating small pockets or voids within said material such that upon curing and hardening of said material said voids are permanently maintained within said material.

8. The material as claimed in claim 7 formed into blocks such that upon curing said blocks comprise concrete blocks.

9. A method of manufacturing cementitious materials, the method comprising the steps of:
(i) forming a mixture of sand, cement, water and fragmented rubber or plastic material, said sand component comprising from 60 to 80 percent by weight of said mixture, said cement component comprising from 5 to 15 percent by weight of said mixture, said water component comprising from 5 to 15 percent by weight of said mixture, said fragmented rubber or plastic material comprising from 5 to 15 percent by weight of said mixture;
(ii) subjecting said sand, cement, water and fragmented rubber or plastic mixture to an autoclave process wherein said fragments of rubber or plastic material expand creating small pockets or voids within said mixture, said mixture curing and hardening during said autoclave process such that said pockets or voids become permanently entrained within said hardened mixture.

10. The method as claimed in claim 9 wherein said fragments of rubber or plastic material are formed through shredding automobile or truck tires into fragments having a size range of from three to four millimetres.

11. The method as claimed in claim 9 wherein said autoclave process is carried out at a temperature of from 160° to 180° Celsius, at a pressure of approximately 16 Bar, and for a time period of from four to eight hours.

12. The method as claimed in claimed 9 including the further step of pressing said sand, cement, water and fragmented rubber or plastic mixture into molds prior to subjecting said mixture to said autoclave process such that said autoclave process results in the production of concrete products of a desired shape.
